(19) United States
(12) Patent Application Publication
(10) Pub. No.: US 2017/0202051 A1
(43) Pub. Date: Jul. 13, 2017

(54) METHOD AND APPARATUS FOR REUSING ACCESS STRATUM CONTEXT THROUGH UNIQUE BASE STATION IDENTIFIER, AND METHOD AND APPARATUS FOR RESUMING RADIO RESOURCE CONTROL (RRC) CONNECTION BY USING THE SAME

(71) Applicant: Electronics and Telecommunications Research Institute, Daejeon (KR)

(72) Inventor: Hyun-Yong HWANG, Sejong-si (KR)

(73) Assignee: Electronics and Telecommunications Research Institute, Daejeon (KR)

(21) Appl. No.: 15/403,464

(22) Filed: Jan. 11, 2017

(30) Foreign Application Priority Data
Jan. 12, 2016 (KR) 10-2016-0003476
Jan. 14, 2016 (KR) 10-2016-0004542
Sep. 21, 2016 (KR) 10-2016-0120961

(51) Int. Cl. H04W 76/04; H04W 74/00

(52) U.S. Cl. CPC H04W 76/046; H04W 74/002; H04W 88/08

(57) ABSTRACT

Provided is a method for resuming, by a first base station, a radio resource control (RRC) connection suspended by a second base station. The first base station receives an RRC connection resume request message including a first identifier and a resume identifier for identifying the second base station from a terminal. The first base station identifies the second base station using the first identifier. Further, the first base station acquires access stratum (AS) context information matching the resume identifier from the second base station, using the resume identifier.

### CROSS-REFERENCE TO RELATED APPLICATION

This application claims priority to and the benefit of Korean Patent Application No. 10-2016-0003476, 10-2016-0004542, and 10-2016-0120961 filed in the Korean Intellectual Property Office on Jan. 12, 2016, Jan. 14, 2016, and Sep. 21, 2016, respectively, the entire contents of which are incorporated herein by reference.

### BACKGROUND OF THE INVENTION

(a) Field of the Invention

The present invention relates to a method and an apparatus for reusing an access stratum (AS) context through a unique base station identifier.

In addition, the present invention relates to a method and apparatus for resuming a radio resource control (RRC) connection.

(b) Description of the Related Art

The existing mobile communication system requires messages (for example, random access preamble message, radio resource control (RRC) connection reconfiguration complete message, or the like) for 9 connection configuration procedures to transmit and receive data on a radio interface between a terminal and a base station.

When the mobile communication system is applied to applications for intermittently transmitting a small size of data like internet of things (IoT), a size of transmitted data is relatively smaller than the number of messages for connection configuration and a size of these messages. For this reason, a signaling overhead problem occurs. As a result, a method for supplementing the above problem is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for reducing signaling overhead and battery consumption due to a connection reconfiguration procedure.

An example embodiment of the present invention provides a method for resuming, by a first base station, a radio resource control (RRC) connection suspended by a second base station. The method includes: receiving an RRC connection resume request message including a resume identifier and a first identifier for identifying the second base station from a terminal; identifying the second base station using the first identifier; and acquiring access stratum (AS) context information matching the resume identifier from the second base station, using the resume identifier.

The acquiring may include acquiring the AS context information from the second base station through at least one of an X2 interface using an X2-application protocol (X2-AP) and an S1 interface using an S1-AP.

The first identifier may include at least one of a global base station identifier, a physical cell identifier (PCI), an evolved-universal terrestrial radio access network (E-UTRAN) cell global identifier (ECGI), and an E-UTRAN cell identifier (ECI), corresponding to the second base station.

The method may further include: transmitting an RRC connection resume complete message including a second identifier for identifying the first base station resuming the RRC connection to the terminal.

The receiving may include receiving the RRC connection resume request message from the terminal in an RRC idle state when the base station that the terminal in the RRC idle state accesses is changed from the second base station to the first base station.

The second base station may transmit the RRC connection suspend message including the first identifier and the resume message to the terminal when the RRC connection is suspended.

Another embodiment of the present invention provides a method for resuming, by a terminal, a radio resource control (RRC) connection suspended by a first base station. The method includes: transmitting an RRC connection resume request message including a resume identifier for searching access stratum (AS) context information of the RRC connection and a first identifier for searching the first base station storing the AS context information to a second base station different from the first base station; and receiving an RRC connection resume complete message including a second identifier for identifying the second base station from the second base station when the RRC connection is resumed by the second base station.

The transmitting may include transmitting the RRC connection resume request message to the second base station in an RRC idle state when the base station that the terminal in the RRC idle state accesses is changed from the first base station to the second base station.

The method may further include: prior to the transmitting, receiving an RRC connection suspend message including the resume identifier and the first identifier and suspending of the RRC connection from the first base station.

The first identifier may include at least one of a global base station identifier, a physical cell identifier (PCI), an evolved-universal terrestrial radio access network (E-UTRAN) cell global identifier (ECGI), and an E-UTRAN cell identifier (ECI), corresponding to the first base station.

Yet another embodiment of the present invention provides a second base station resuming a radio resource control (RRC) connection suspended by a first base station. The second base station includes: a memory; and a processor connected to the memory and determining the first base station storing access stratum (AS) context information for the RRC connection using a first identifier included in an RRC connection resume request message received from a terminal, in which the processor may acquire the AS context information from the first base station using a resume identifier included in the RRC connection resume request message.

The processor may acquire the AS context information from the first base station using the resume identifier included in the RRC connection resume request message.

### BRIEF DESCRIPTION OF THE DRAWINGS

FIG. 1 is a diagram illustrating a connection configuration procedure of a mobile communication network.

FIG. 2 is a diagram illustrating a resume try procedure using a user plane (UP) solution when AS context information is not present in a base station.

FIG. 3 is a diagram illustrating a method for reusing an AS context using a unique base station identifier and an RRC connection suspend procedure based on the same, according to an exemplary embodiment of the present invention.

FIG. 4 is a diagram illustrating a resume try procedure using a UP solution when the AS context information is not present in the base station, according to the exemplary embodiment of the present invention.

FIG. 5 is a diagram illustrating a wireless device (or communication node) according to an exemplary embodiment of the present invention.

### DETAILED DESCRIPTION OF THE EMBODIMENTS

In the following detailed description, only certain example embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the present specification, the overlapping description of the same components will be omitted.

Further, in the present specification, it is to be understood that when one component is referred to as being “connected to” or “coupled to” another element, it may be connected directly to or coupled directly to another element or be connected to or coupled to another element, having the other element intervening therebetween. On the other hand, in the present specification, it is to be understood that when one element is referred to as being “connected directly to” or “coupled directly to” another element, it may be connected to or coupled to another element without the other element intervening therebetween.

Further, terms used in the present specification are used only in order to describe specific exemplary embodiments rather than limiting the present invention.

Further, in the present specification, singular forms may be intended to include plural forms unless the context clearly indicates otherwise.

Further, in the present specification, it will be further understood that the terms “include” or “have” used in the present specification, specify the presence of features, numerals, steps, operations, components, parts mentioned in the present specification, or a combination thereof, but do not preclude the presence or addition of one or more other features, numerals, steps, operations, components, parts, or a combination thereof.

Further, in the present specification, the term “and/or” includes a combination of a plurality of relevant items or any of a plurality of relevant items. In the present specification, ‘A or B’ may include ‘A’, ‘B’, or ‘A and B’.

Further, in the present specification, a terminal may refer to a mobile terminal, a mobile station, an advanced mobile station, a high reliability mobile station, a subscriber station, a portable subscriber station, an access terminal, user equipment, and the like and may also include all or some of the functions of the terminal, the mobile terminal, the mobile station, the advanced mobile station, the high reliability mobile station, the subscriber station, the portable subscriber station, the access terminal, the user equipment, and the like.

Further, in the present specification, a base station (BS) may refer to an advanced base station, a high reliability base station, a nodeB, an evolved node B (eNodeB, eNB), an access point, a radio access station, a base transceiver station, a mobile multihop relay (MMR)-BS, a relay station serving as a base station, a high reliability relay station serving as a base station, a repeater, a macro base station, a small base station, and the like and may also include functions of all or some of the base station, the advanced base station, the HR-BS, the nodeB, the eNodeB, the access point, the radio access station, the base transceiver station, the MMR-BS, the relay station, the high reliability relay station, the repeater, the macro base station, the small base station, and the like.

The reference to cat least one of as used herein to describe embodiment(s) may include one or any combination of the elements or items to which it subsequently refers.

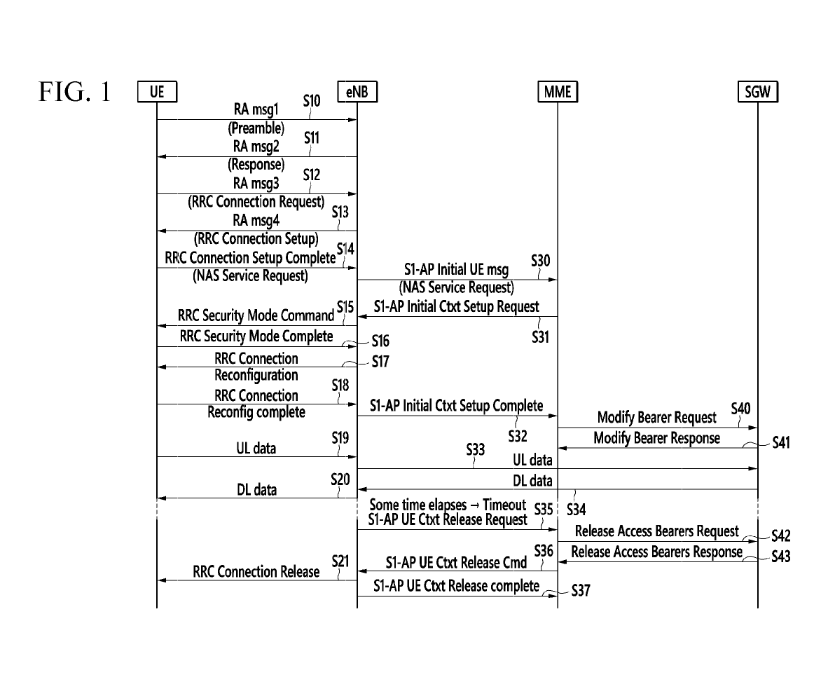

FIG. 1 is a diagram illustrating a connection configuration procedure of a mobile communication network.

In detail, FIG. 1 illustrates connection procedures (S10 to S43) which a terminal and a base station require to transmit and receive data in a mobile communication system.

The terminal transmits a random access (RA) message (preamble) to the base station (S10).

The base station transmits an RA message (response) to the terminal (S11).

The terminal transmits the RA message (RRC connect request) to the base station (S12).

The base station transmits the RA message (RRC connect setup) to the terminal (S13).

The terminal transmits an RRC connection setup complete message (non-access stratum (NAS) service request) to the base station (S14).

The base station transmits an S1-application protocol (AP) initial UE message (NAS service request) to a mobility management entity (MME) (S30).

The MME transmits an S1-AP initial context setup request message to the base station (S31).

The base station transmits an RRC security mode command message to the terminal (S15).

The terminal transmits an RRC security mode complete message to the base station (S16).

The base station transmits an RRC connection reconfiguration message to the terminal (S17).

The terminal transmits an RRC connection reconfiguration complete message to the base station (S18).

The base station transmits an S1-AP initial context setup complete message to the MME (S32).

The MME transmits a bearer modification request message to a serving gateway (SGW) (S40).

The SGW transmits a bearer modification response message to the MME (S41).

The terminal transmits an uplink data to the base station (S19) and the base station transmits the received uplink data to the SGW (S33).

The SGW transmits a downlink data to the base station (S34) and the base station transmits the received downlink data to the terminal (S20).

When being time out after a predetermined time lapses, the base station transmits an S1-AP-UE context release request message to the MME (S35).

The MME transmits an access bearer release request message to the SGW (S42).

The SGW transmits an access bearer release response message to the MME (S43).

The MME transmits an S1-AP UE context release command message to the base station (S36).

The base station transmits an RRC connection release message to the terminal (S21).

The base station transmits an S1-AP UE context release complete message to the MME (S37).

The existing mobile communication system requires messages (for example, random access preamble message, random access response message, . . . , RRC connection reconfiguration complete message) for 9 connection configuration procedures (S10, S11, . . . , S18) to transmit and receive data on a radio interface between the terminal and the base station.

When the mobile communication system is applied to applications for intermittently transmitting a small size of data like internet of things (IoT), a size of transmitted data is relatively smaller than the number of messages for connection configuration and a size of these messages. For this reason, a signaling overhead problem occurs. As a result, a method for supplementing the above problem is required.

The 3rd generation partnership project (3GPP) service and system aspects 2 (SA2) determines cellular IoT (Clot) architecture for narrowband (NB)-IoT. For this purpose, the 3GPP SA2 determines solution 2 as a control plane (CP) solution and solution 18 as a user plane (UP) solution. In particular, the UP solution uses an RRC connection suspend procedure and an RRC connection resume procedure. The UP solution may have advantages of reducing the signaling overhead and the battery consumption of the terminal.

In the RRC connection suspend procedure, the base station transmits the RRC connection suspend message to the terminal to issue a command to change the terminal state from an RRC connection (RRC_connected) state to an RRC idle (RRC_idle) state and hold AS context information in the terminal without deleting the AS context information. Further, the base station provides a resume identifier (resume ID) to the terminal, by including the resume ID in the RRC connection suspend message to the terminal. By doing so, the AS context information held by the base station later may be searched.

In the RRC connection resume procedure, the terminal transmits an RRC connection resume request message to the base station to notify the base station that there is a data to be transmitted by the terminal. Further, the terminal provides the resume identifier (resume ID) previously received from the base station to the base station, by including the resume identifier in the RRC connection resume request message. By doing so, the AS context information stored in the base station may be searched and reused.

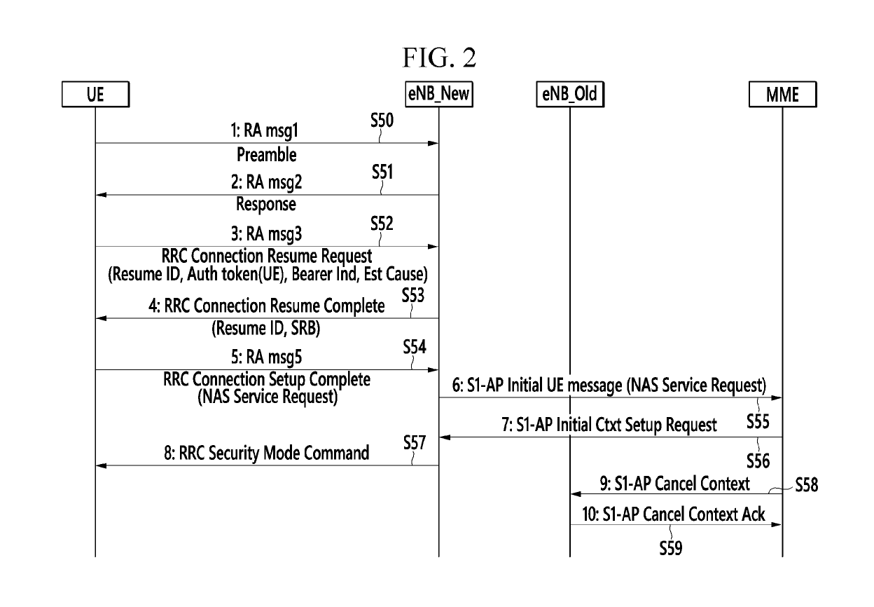

FIG. 2 is a diagram illustrating a resume try procedure using a user plane (UP) solution when AS context information is not present in a base station.

In detail, FIG. 2 illustrates a try procedure for the RRC connection resume, when the AS context information is not present in the base station which the terminal accesses.

If the accessed base station is changed from the previous base station (eNB_Old) to a new base station (eNB_New) while the terminal is in the RRC_idle state, the terminal performs the RRC connection resume procedure. At this point, the new base station (eNB_New) does not have the AS context information that has been used in the previous connection. Therefore, the terminal needs to perform connection configuration procedures S50 to S59 along with the new base station (eNB_New) again from the beginning.

That is, the terminal transmits the RA message (preamble) to the new base station (eNB_New) (S50). The new base station (eNB_New) transmits the RA message (response) to the terminal (S51). The terminal transmits the RRC connection resume request message (resume ID, authentication token(UE), bearer indication, establishment cause) as the RA message to the new base station (eNB_New) (S52). The new base station (eNB_New) transmits an RRC connection resume complete message (resume ID, SRB(signaling radio bearer)) to the terminal (S53). The terminal transmits an RRC connection setup complete message (NAS service request) as the RA message to the new base station (eNB_New) (S54). The new base station (eNB_New) transmits an S1-AP initial UE message (NAS service request) to the MME (S55). The MME transmits an S1-AP initial context setup request message to the new base station (eNB_New) (S56). The new base station (eNB_New) transmits an RRC security mode command message to the terminal (S57). The MME transmits an S1-AP cancellation context message to the previous base station (eNB_Old) (S58). The previous base station (eNB_Old) transmits an S1-AP cancellation context response message to the MME (S59).

Due to the re-performance of the connection configuration procedures (S50-S59), the advantages of the reduction in the signaling overhead of the existing UP solution disappear and the battery consumption of the terminal is caused.

Therefore, a method for reducing signaling overhead and reducing battery consumption that occurs when an accessed base station is changed while a terminal is in an RRC_idle state and AS context information that a previous base station eNB_Old has used is not present in a new base station (eNB_New) is essentially required.

Hereinafter, when the accessed base station is changed while the terminal in the mobile communication network is in the RRC_idle state and the AS context information stored for the terminal is not present in the new base station which the terminal newly accesses, a method for fetching, by a base station (hereinafter, ‘second base station’) that the terminal newly accesses, AS context information from a base station (hereinafter, ‘first base station’) that a terminal previously accesses and reusing the AS context information will be described. Alternatively, the base station the terminal newly accesses may be referred to ‘a first base station’ and the base station by the terminal may be referred to ‘a second base station.’

In detail, before the terminal is changed from the RRC_Connected state to the RRC_Idle state, a first base station may transmit its own unique base station identifier information to the terminal. Before the terminal is changed from the RRC_Idle state to the RRC_Connected state, the previously received unique base station identifier information may be transmitted to the second base station. When the accessed base station is changed in the RRC_idle state of the terminal and the AS context information for the terminal is not present in the second base station due to the change, the second base station may find the first base station and may fetch the AS context information for the terminal from the first base station and reuse the fetched AS context information.

That is, the terminal and the base station transmit and receive the unique base station identifier through the message. Even if the base station (accessed base station) that the terminal accesses is changed from the first base station to the second base station and thus the AS context information for the terminal stored in the first base station may not be used, the second base station may use the unique base station identifier to find the first base station. Further, the second base station may acquire the AS context information from the first base station and reuse the acquired AS context information. By doing so, the procedures (for example, procedures of FIG. 2) for the connection between the terminal and the base station may be omitted and the battery loss of the terminal due to the connection procedures (for example, procedures of FIG. 2) may be reduced.

In the RRC connection suspend procedure, the first base station may transmit the RRC connection suspend message to the terminal to change the terminal state from the RRC_Connected state to the RRC_Idle state. At this point, the first base station may transmit a global base station identifier (global eNB ID) that is the unique base station identifier and the resume identifier (resume ID) included in the RRC connection suspend message to the terminal. The global base station identifier (global eNB ID) of the base station does not overlap a global base station identifier (global eNB ID) of another base station.

When the AS context information stored for the corresponding terminal is not present in the second base station due to the change in the accessed base station in the RRC_Idle state of the terminal, the second base station may find the first base station storing the corresponding AS context information using the global base station identifier information and acquire and reuse the AS context information from the first base station.

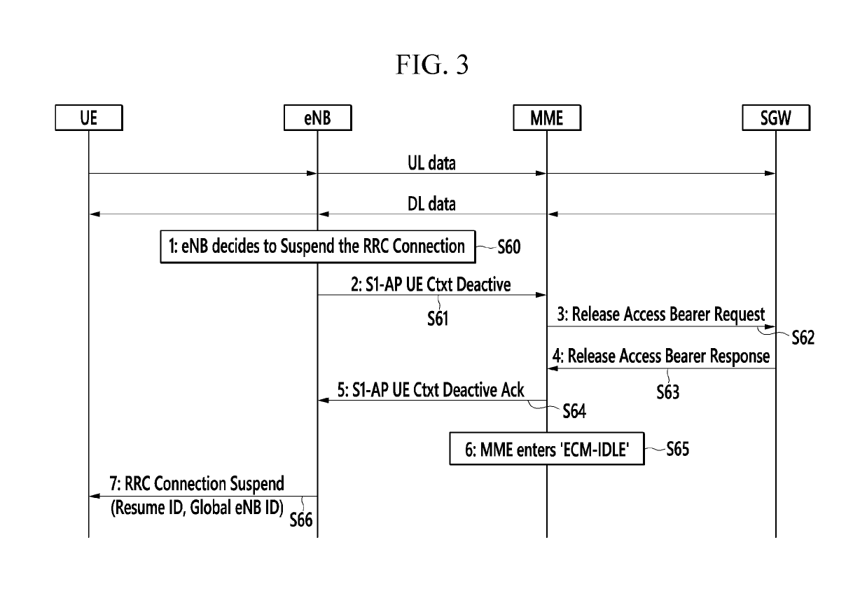

FIG. 3 is a diagram illustrating a method for reusing an AS context using a unique base station identifier and an RRC connection suspend procedure based on the same, according to an exemplary embodiment of the present invention.

The terminal transmits the uplink data to the base station and the base station transmits the downlink data to the terminal.

If the base station decides to suspend the RRC connection (S60), the base station transmits an S1-AP UE context inactive (deactive) message to the MME (S61).

The MME transmits an access bearer release request message to the SGW (S62).

The SGW transmits an access bearer release response message to the MME (S63).

The MME transmits an S1-AP UE context inactive (deactive) response message to the base station (S64).

The MME enters an ECM (evolved packet system (EPS) connection management) idle(ECM-Idle) state (S65).

The base station transmits the RRC connection suspend message (resume ID, global eNB ID) to the terminal (S66).

In the RRC connection suspend procedure (for example, S66), the base station provides the global base station identifier (global eNB ID) as well as the resume identifier (resume ID) to the terminal. Here, the resume identifier (resume ID) is used to search the AS context information stored in the base station. The AS context information is for the RRC connection. Further, the global base station identifier (global eNB ID) is the unique base station identifier used to search the base station in which the AS context information is stored.

The base station transmits the RRC connection suspend message including the resume identifier (resume ID) and the global base station identifier (global eNB ID) to the terminal. In detail, when the base station transmits the RRC connection suspend message to the terminal, a timer that indicates a storage life of the corresponding AS context information may be operated. This is to solve the problem in that the corresponding AS context information stored in the base station is permanently stored in the base station when the problem occurs in the terminal receiving the RRC connection suspend message and thus the RRC connection for the corresponding terminal is not resumed. The base station deletes the corresponding AS context information when the timer indicating the storage life of the AS context information expires.

Meanwhile, according to the exemplary embodiment different from the exemplary embodiment of FIG. 3, the global base station identifier (global eNB ID) that is the unique base station identifier may be replaced by a physical cell identifier (PCI), an evolved-universal terrestrial radio access network (E-UTRAN) cell global identifier (ECGI), an E-UTRAN cell identifier (ECI), or the like. In this case, the base station transmits the RRC connection suspend message including identifiers (for example, at least one of PCI, ECGI, and ECI) corresponding to the base station to the terminal, along with the resume identifier (resume ID)

Meanwhile, the base station of FIG. 3 is the foregoing first base station.

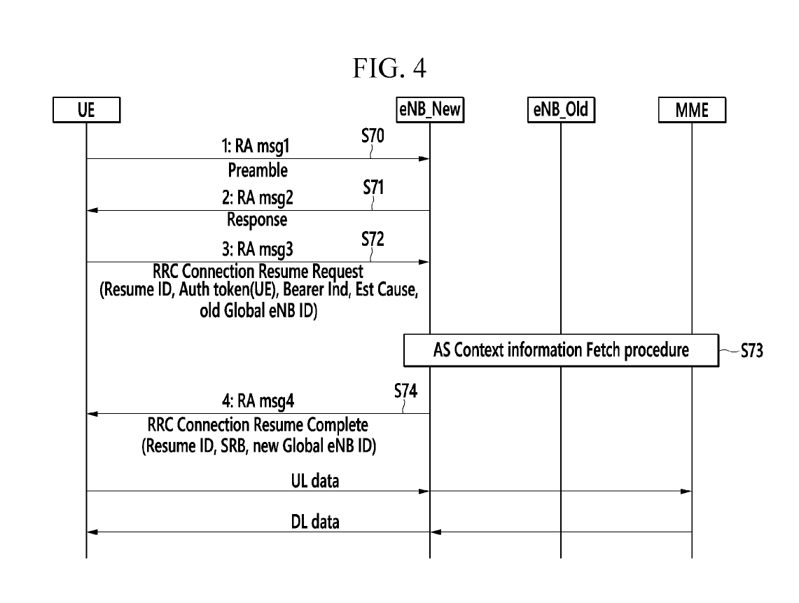

FIG. 4 is a diagram illustrating a resume try procedure using a UP solution when the AS context information is not present in the base station, according to the exemplary embodiment of the present invention.

In the RRC connection resume procedure, the terminal transmits the RA message (preamble) to the new base station (eNB_New) (S70) and the new base station (eNB_New) transmits the RA message (response) to the terminal (S71).

In the RRC connection resume procedure, the terminal transmits the RRC connection resume request message as the RA message to the new base station (eNB_New) (S72). In detail, when the base station (accessed base station) that the terminal in the RRC_Idle state accesses is changed from the previous base station (eNB_Old) to the new base station (eNB_New), the terminal in the RRC_Idle state may transmit the RRC connection resume request message to the new base station (eNB_New). Here, the RRC connection resume request message includes the resume identifier (resume ID) and the global base station identifier (global eNB ID) that the terminal receives from the base station in the previous process (for example, process S66). That is, the RRC connection resume request message includes the identifiers (for example, global eNB ID, PCI, ECGI, ECI, or the like) for identifying the base station (eNB_Old) that suspends the RRC connection. Further, the RRC connection resume request message may further include an authentication token (UE) and a bearer indication and establishment cause.

The new base station (eNB_New), the previous base station (eNB_Old), and the MME perform an AS context information patch procedure (S73). In detail, if the AS context information is not present in the new base station (eNB_New) due to the change in the accessed base station, the new base station (eNB_New) may find (or identify, determine) the previous base station (eNB_Old) using the global base station identifier (old Global eNB ID) of the previous base station (eNB_Old) received from the terminal in process S72. Further, the new base station (eNB_New) may search the AS context information (AS context information matching (corresponding to) the resume ID) for the terminal from the previous base station (eNB_Old) using the resume identifier (resume ID) received from the terminal and fetch the searched AS context information. For this purpose, the new base station (eNB_New) may fetch the AS context information through an X2 interface using X2-AP or an S1 interface using S1-AP.

The new base station (eNB_New) fetches the AS context information and then (i.e., when the RRC connection is resumed by the new base station (eNB_New)) transmits the RRC connection resume complete message to the terminal and reuses the AS context information acquired in process S73 (S74). The accessed base station is changed from the previous base station (eNB_Old) to the new base station (eNB_New), and therefore the global base station identifier (global eNB ID) included in the RRC connection resume complete message is changed from the global base station identifier (old global eNB ID) of the previous base station (eNB_Old) to the global base station identifier (new global eNB ID) of the new base station (eNB_New). That is, the RRC connection resume complete message includes the identifiers (for example, global eNB ID, PCI, ECGI, ECI, or the like) for identifying the base station (eNB_New) that resumes the RRC connection. Further, the RRC connection resume complete message may further include the resume identifier (resume ID) and an SRB.

The terminal transmits the uplink data to the new base station (eNB_New) and the new base station (eNB_New) transmits the downlink data to the terminal.

Meanwhile, according to the exemplary embodiment of the present invention different from the exemplary embodiment of FIG. 4, the global base station identifier (global eNB ID) that is the unique base station identifier may be replaced by PCI, ECGI, ECI, or the like. In this case, the terminal transmits the RRC connection resume request message including the identifiers (for example, at least one of PCI, ECGI, and ECI) corresponding to the previous base station (eNB_Old) to the new base station (eNB_New), along with the resume identifier (resume ID)

In FIG. 4, the new base station (eNB_New) is the foregoing second base station and the previous base station (eNB_Old) is the foregoing first base station.

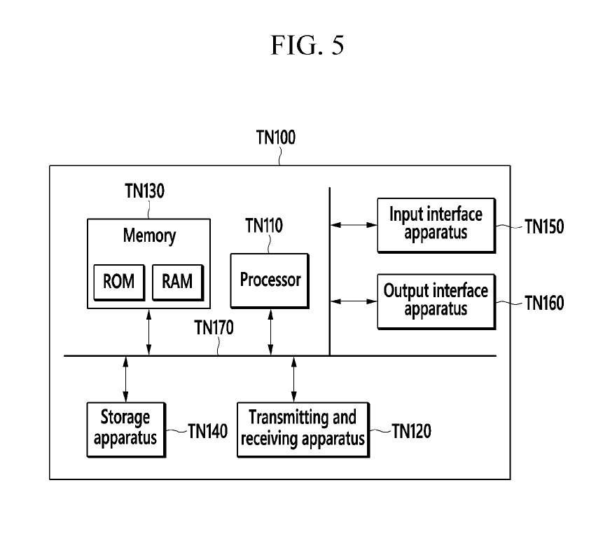

FIG. 5 is a diagram illustrating a wireless device (or communication node) according to an exemplary embodiment of the present invention.

A wireless device TN100 may be the base station, the terminal, or the like described in the present specification and may be a transmitter or a receiver.

In the exemplary embodiment of FIG. 5, the wireless device TN100 may include at least one processor TN110, a transmitting/receiving apparatus TN120 connected to a network to perform communication, and a memory TN130. Further, the wireless device TN100 may further include a storage apparatus TN140, an input interface apparatus TN150, an output interface apparatus 160, or the like. Components included in the wireless device TN100 may be connected to each other by a bus TN170 to communication with each other.

The processor TN110 may run a program command that is stored in at least one of the memory TN130 and the storage apparatus TN140. The processor TN110 may mean a central processing unit (CPU), a graphics processing unit (GPU), or an exclusive process that performs methods according to exemplary embodiments of the present invention. The processor TN110 may be configured to implement the procedures, the functions, and the methods described with reference to the exemplary embodiment of the present invention. The processor TN110 may control each of the components of the wireless device TN100.

The memory TN130 and the storage apparatus TN140 may each store various information associated with the operation of the processor TN110. The memory TN130 and the storage apparatus TN140 may each be configured of at least one of a volatile storage medium and a non-volatile storage medium. For example, the memory TN130 may be configured of at least one of a read only memory (ROM) and a random access memory (RAM).

The transmitting/receiving apparatus TN120 may transmit or receive a wired signal or a wireless signal. Further, the wireless device TN100 may have a single antenna or a multiple antenna.

According to an exemplary embodiment of the present invention, the base station to which the terminal is newly connected may find the base station previously accessed by the corresponding terminal through the unique base station identifier and reuse the AS context information held by the previous base station. As a result, it is possible to reduce the signaling overhead and the battery consumption of the terminal due to the connection reconfiguration procedure.

The exemplary embodiments of the present invention are not implemented only by the apparatus and/or method as described above, but may be implemented by programs realizing the functions corresponding to the configuration of the exemplary embodiments of the present invention or a recording medium recorded with the programs, which may be readily implemented by a person having ordinary skill in the art to which the present invention pertains from the description of the foregoing exemplary embodiments.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A method for resuming, by a first base station, a radio resource control (RRC) connection suspended by a second base station, the method comprising:
receiving, from a terminal, an RRC connection resume request message including a resume identifier and a first identifier for identifying the second base station, the resume identifier included in the RRC connection resume request message being received from the second base station;
identifying the second base station using the first identifier received through the RRC connection resume request message; and
acquiring access stratum (AS) context information matching the resume identifier received from the second base station through the terminal via the RRC connection resume request message.

2. The method of claim 1, wherein the AS context information is acquired from the second base station through at least one of an X2 interface using an X2-application protocol (X2-AP) and an S1 interface using an S1-AP.

3. The method of claim 1, wherein:
the first identifier includes at least one of a global base station identifier, a physical cell identifier (PCI), an evolved-universal terrestrial radio access network (E-UTRAN) cell global identifier (ECGI), and an E-UTRAN cell identifier (ECI), corresponding to the second base station.

4. The method of claim 1, further comprising:
transmitting an RRC connection resume complete message including a second identifier for identifying the first base station resuming the RRC connection to the terminal.

5. The method of claim 1, wherein the RRC connection resume request message is received provided the terminal is in an RRC idle state and access of the terminal in the RRC idle state is changed from the second base station to the first base station.

6. The method of claim 1, wherein the second base station transmits an RRC connection suspend message including the first identifier and the resume message to the terminal provided the RRC connection is suspended.

7. A method for resuming, by a terminal, a radio resource control (RRC) connection suspended by a first base station, the method comprising:
transmitting an RRC connection resume request message including a resume identifier for searching access stratum (AS) context information of the RRC connection and a first identifier for searching the first base station storing the AS context information to a second base station, the second base station being different from the first base station; and
receiving an RRC connection resume complete message including a second identifier for identifying the second base station from the second base station provided the RRC connection is resumed by the second base station.

8. The method of claim 7, wherein the RRC connection resume request message is transmitted to the second base station in an RRC idle state provided the terminal in the RRC idle state and access of the terminal is changed from the first base station to the second base station.

9. The method of claim 7, wherein prior to the transmitting, the method further comprises:
receiving an RRC connection suspend message including the resume identifier and the first identifier for suspending of the RRC connection from the first base station.

10. The method of claim 7, wherein the first identifier includes at least one of a global base station identifier, a physical cell identifier (PCI), an evolved-universal terrestrial radio access network (E-UTRAN) cell global identifier (ECGI), and an E-UTRAN cell identifier (ECI), corresponding to the first base station.

11. A second base station resuming a radio resource control (RRC) connection suspended by a first base station, the second base station comprising:
a memory; and
a processor connected to the memory to cause the processor to:
determine the first base station storing access stratum (AS) context information for the RRC connection using a first identifier included in an RRC connection resume request message received from a terminal,
acquire the AS context information from the first base station using a resume identifier included in the RRC connection resume request message.

12. The second base station of claim 11, wherein the first identifier
includes at least one of a global base station identifier, a physical cell identifier (PCI), an evolved-universal terrestrial radio access network (E-UTRAN) cell global identifier (ECGI), and an E-UTRAN cell identifier (ECI), corresponding to the first base station.

13. The second base station of claim 11, wherein the processor acquires the AS context information from the first base station through an X2 interface using an X2-application protocol (X2-AP).

14. The second base station of claim 11, wherein the processor transmits an RRC connection resume complete message including the resume identifier and a second identifier for identifying the second base station to the terminal provided the RRC connection is resumed.

15. The second base station of claim 11, wherein the resume identifier and the first identifier are transmitted from the first base station to the terminal provided the RRC connection is suspended.

16. The second base station of claim 11, wherein the processor receives the RRC connection resume request message from the terminal in an RRC idle state and access of the terminal in the RRC idle state is changed from the first base station to the second base station.
